(19) United States
(12) Patent Application Publication
(10) Pub. No.: US 2026/0120415 A1
(43) Pub. Date: Apr. 30, 2026

(54) METHOD AND SYSTEM FOR AUTHORING AND RENDERING EXTENDED REALITY EXPERIENCES

(71) Applicant: HCL Technologies Limited, New Delhi (IN)

(72) Inventors: Ramprasath Venugopal, Bangalore (IN); Sathish Anand Sadhanandan, Chennai (IN); Harshit Gaur, Noida (IN); Divyansh Singh, Noida (IN)

(21) Appl. No.: 19/086,333

(22) Filed: Mar. 21, 2025

(30) Foreign Application Priority Data
Oct. 28, 2024 (IN) 202411082456

(51) Int. Cl. G06T 19/00; G06T 13/20

(52) U.S. Cl. CPC G06T 19/006; G06T 13/20

(57) ABSTRACT

A method and system for authoring and rendering extended reality (XR) experience is disclosed. A processor receives a training module for the XR experience. A video of a real-world scenario of an equipment corresponding to the XR experience is received. A set of image frames are detected in the video corresponding to a portion of the set of views based on the detection of the one or more real-world objects and the one or more training objects in the video. A first set of three-dimensional (3D) views for each of the set of views and a second set of 3D views for each of the set of image frames are created. A unified XR content package is generated for the XR experience based on the first set of 3D views, the second set of 3D views and the anchor specification.

### TECHNICAL FIELD

This disclosure relates generally to extended reality, and more particularly to method and system for authoring and rendering extended reality (XR) experiences to provide assistance during an operation performed on an equipment.

### BACKGROUND

The use of Extended Reality (XR) technologies, which include Augmented Reality (AR) and Virtual Reality (VR), has gained more acceptance as a training and operational aid in a variety of sectors. These technologies are employed in creating XR experiences that involve complex steps related to job aids, guided instructions, training, and inspections performed on an equipment, which are hard to communicate through certain alternatives. The common methods of delivering the relevant experience use features such as the text in the form of manuals, charts, and physical representation with the instructor demonstrating the skills, which is less likely to capture the users and the important details for customizing rendering of the experience as per real-time scenario. In this way, users may find it hard to appreciate the experience end up making errors in the actual performance which may result in wastage of productive time of the user.

Further, existing XR experience systems may often struggle to bridge the gap between realistic situations and their digitally constructed counterparts. Such systems may not have the ability to update with respect to the user actions in real time or to provide a thorough gradual procedures to perform an operation that fits the reality. This particular shortcoming is likely to affect the effectiveness of the XR experience and not fully exploit the capabilities offered by XR technologies. Existing XR experience systems may also fail to include real-time dynamic equipment and equipment operating condition. Many of these systems may also not be able to effectively interrelate physical and virtual spaces.

Therefore, there is a need for an efficient methodology of authoring and rendering extended reality experiences.

### SUMMARY OF THE INVENTION

In an embodiment, a method of authoring and rendering extended reality (XR) experience to provide assistance during an operation performed on an equipment is disclosed. The method may include receiving, by an authoring and rendering device, a training module for the XR experience. In an embodiment, the training module may include a set of views arranged in a predefined sequence for performing the operation. In an embodiment, each of the set of views may include one or more real-world objects and one or more training objects corresponding to the equipment. The training module may further include an anchor specification corresponding to each of the set of views. The training module may further include a set of animation steps associated with the one or more real-world objects and the one or more training objects. In an embodiment, the set of animation steps may correspond to one or more steps to be performed for performing the operation. The training module may further include metadata corresponding to each of the set of animation steps. The method may further include receiving, by the authoring and rendering device, a video of a real-world scenario of the equipment corresponding to the XR experience. The method may further include detecting, by the authoring and rendering device, a set of image frames in the video corresponding to a portion of the set of views based on the detection of the one or more real-world objects and the one or more training objects in the video. The method may further include creating, by the authoring and rendering device, a first set of three-dimensional (3D) views for each of the set of views and a second set of 3D views for each of the set of image frames using a 3D-modelling tool. The method may further include generating, by the authoring and rendering device, a unified XR content package for the XR experience based on the first set of 3D views, the second set of 3D views and the anchor specification. The generation of the unified XR content package may include determining, by the authoring and rendering device, a set of augmented views by augmenting the second set of 3D views with respect to a portion of the first set of 3D views corresponding to the portion of the set of views based on the anchor specification. The generation of the unified XR content package may further include compiling, by the authoring and rendering device, the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package. In an embodiment, the unified XR content package may include a plurality of file formats that may be compatible with a plurality of viewing devices. The method may further include rendering, by the authoring and rendering device, the XR experience on one or more of the plurality of viewing devices to provide assistance during the operation. In an embodiment, the XR experience may be rendered based on execution of a corresponding file format from the plurality of file formats compatible with each of the one or more of the plurality of viewing devices.

In another embodiment, a system for authoring and rendering extended reality (XR) experience to provide assistance during an operation performed on an equipment. The system may include an authoring and rendering device. The authoring and rendering device may include a processor and a memory communicably coupled to the processor. The memory stores processor-executable instructions, which when executed by the processor, cause the processor to receive a training module for the XR experience. In an embodiment the training module may include a set of views arranged in a predefined sequence for performing the operation. In an embodiment, each of the set of views may include one or more real-world objects and one or more training objects corresponding to the equipment. The training module may further include an anchor specification corresponding to each of the set of views. The training module may further include a set of animation steps associated with the one or more real-world objects and the one or more training objects. In an embodiment, the set of animation steps correspond to one or more steps to be performed for performing the operation. The training module may further include metadata corresponding to each of the set of animation steps. The processor may further receive a video of a real-world scenario of the equipment corresponding to the XR experience. The processor may further detect a set of image frames in the video corresponding to a portion of the set of views based on the detection of the one or more real-world objects and the one or more training objects in the video. The processor may further create a first set of three-dimensional (3D) views for each of the set of views and a second set of 3D views for each of the set of image frames using a 3D-modelling tool. The processor may further generate a unified XR content package for the XR experience based on the first set of 3D views, the second set of 3D views and the anchor specification. In an embodiment, to generate the unified XR content package, the processor may determine a set of augmented views by augmenting the second set of 3D views with respect to a portion of the first set of 3D views corresponding to the portion of the set of views based on the anchor specification. Further, to generate the unified XR content package, the processor may compile the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package. In an embodiment, the unified XR content package may include a plurality of file formats that may be compatible with a plurality of viewing devices. The processor may further render the XR experience on one or more of the plurality of viewing devices to provide assistance during the operation. In an embodiment, the XR experience may be rendered based on execution of a corresponding file format from the plurality of file formats compatible with each of the one or more of the plurality of viewing devices.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for authoring and rendering extended reality (XR) experience, in accordance with an embodiment of the present disclosure.

FIG. 2 is a functional block diagram of an authoring and rendering device of the exemplary system of FIG. 1, in accordance with an embodiment of the present disclosure.

FIGS. 3A and 3B illustrate a training module, in accordance with an exemplary embodiment of the present disclosure.

FIG. 4 illustrates a three-dimensional (3D) view of a training object, in accordance with an exemplary embodiment of the present disclosure.

FIG. 5 illustrates a Graphic User Interface (GUI) of an XR authoring application for authoring extended reality enabled on the authoring and rendering device of FIG. 1, in accordance with an exemplary embodiment of the present disclosure.

FIG. 6 illustrates a GUI of the XR authoring application for authoring the extended reality, continuing from FIG. 5, in accordance with an exemplary embodiment of the present disclosure.

FIG. 7 illustrates an exemplary deployment scenario depicting rendering of the XR experience authored in FIG. 5 and FIG. 6 on an augmented reality (AR) device, in accordance with an embodiment of the present disclosure.

FIG. 8A, FIG. 8B, FIG. 8C and FIG. 8D illustrate a GUI of a first client application enabled on the AR device of FIG. 7, in accordance with an exemplary embodiment of the present disclosure.

FIG. 9, illustrates an exemplary deployment scenario depicting rendering of the XR experience authored in FIG. 5 and FIG. 6 on a smart device, in accordance with an embodiment of the present disclosure.

FIGS. 10A and 10B illustrate a GUI of a second client application enabled on the smart device of FIG. 9, in accordance with an exemplary embodiment of the present disclosure.

FIG. 11 illustrates a flowchart of a method of authoring and rendering extended reality (XR) experience to provide assistance during an operation performed on an equipment, in accordance with an embodiment of the present disclosure.

FIG. 11A illustrates a flowchart of a method of compiling a set of augmented views of FIG. 11, in accordance with an embodiment of the present disclosure.

FIG. 11B illustrates a flowchart of a method of processing a user query in conjunction with FIG. 11, in accordance with an embodiment of the present disclosure.

FIG. 11C illustrates a flowchart of a method of modulating the rendering of the XR experience in conjunction with FIG. 11, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

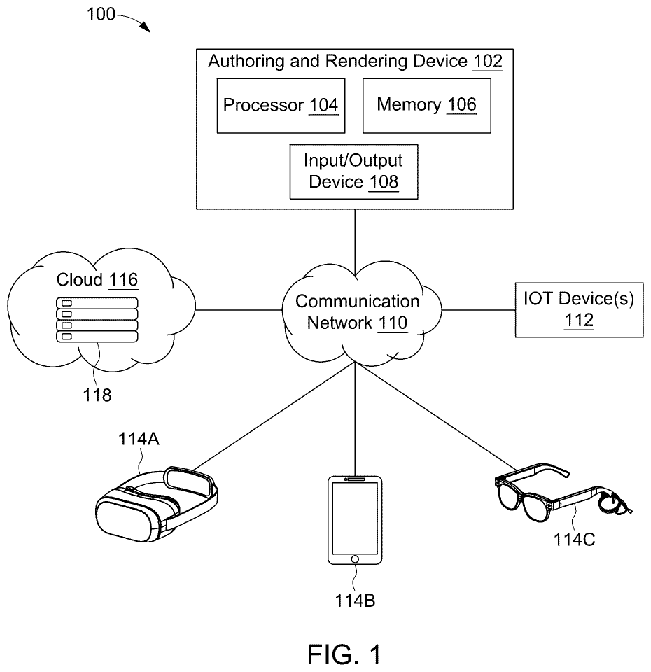

Referring now to FIG. 1, a block diagram of an exemplary system 100 for authoring and rendering extended reality (XR) experience is illustrated, in accordance with an embodiment of the current disclosure. The system 100 may include an authoring and rendering device 102, one or more Internet of Things (IoT) devices 112, and a plurality of viewing devices 114, communicably coupled to each other through a wired or wireless communication network 110. The plurality of viewing devices 114 may include a virtual reality (VR) device 114A, a smart device 114B, and an augmented reality (AR) device 114C. In an embodiment, the plurality of viewing devices 114 may also include a Web Extended Reality (WebXR)-enabled platform which allow users to access and interact with the XR experience via a web browser on desktop devices. WebXR is a web-based standard that supports rendering both the augmented reality (AR) and the virtual reality (VR) experiences directly through compatible web browsers or Application Programming Interface (APIs) without the need for dedicated hardware such as the AR glasses or the VR headsets.

On the other side, the authoring and rendering device 102 may also be communicably coupled to a cloud 116 through the communication network 110. The cloud 116 may include a server 118. In an embodiment, the server 118 may include a database to store a unified XR content package for authoring and rendering the XR experience. In an embodiment, the server 118 may also store data input by the one or more IoT devices 112 or output generated by the authoring and rendering device 102. To this end, the authoring and rendering device 102 may include a processor 104, a memory 106, and an input/output (I/O) device 108.

In an embodiment, processor(s) 104 may include but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store processor-executable instructions that, when executed by the processor 104, cause the processor 104 to author and render XR experience, as will be discussed in greater details herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may include variety of interface(s), for example, interfaces for data input and output devices, and the like. The I/O device 108 may facilitate inputting of instructions by a user communicating with the authoring and rendering device 102. In an embodiment, the I/O device 108 may be wirelessly connected to the authoring and rendering device 102 through wireless network interfaces such as Bluetooth®, infrared, or any other wireless radio communication known in the art. In an embodiment, the I/O device 108 may be connected to a communication pathway for one or more components of the authoring and rendering device 102 to facilitate the transmission of inputted instructions and output results of data generated by various components such as, but not limited to, processor(s) 104 and memory 106.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 110 can include a variety of network devices, including routers, bridges, servers, computing devices, storage devices, and the like.

In an embodiment, the authoring and rendering device 102 may receive a user input for authoring and rendering the extended reality (XR) experience from the I/O device 108 of the authoring and rendering device 102. In an embodiment, the authoring and rendering device 102 may be a computing system, including but not limited to, a smart phone, a laptop computer, a desktop computer, a notebook, a workstation, a server, a portable computer, a handheld, or a mobile device. In an embodiment, the authoring and rendering device 102 may be, but not limited to, in-built into the plurality of viewing devices 114 or may be a standalone computing device.

In an embodiment, the authoring and rendering device 102 may perform various processing in order to author and render the XR experience to provide assistance during an operation performed on an equipment. For example, a technician working to disassemble and reassemble a complex machine, such as a pneumatic cylinder, uses AR glasses to view real-time visual guidance to perform the operation of disassembly and assembly. By way of an example, the authoring and rendering device 102 may receive a training module for the XR experience in order to provide real-time visual guidance in performing the operation. It should be noted that the training module may be provided by a user via the I/O device 108. In an embodiment, the training module may include a set of views arranged in a predefined sequence for performing the operation. It is to be noted that each of the set of views may correspond to a set of steps to be performed while performing the operation in real time. In an embodiment, each of the set of views may include one or more real-world objects and one or more training objects corresponding to the equipment. In an embodiment, the one or more real-world objects and the one or more training objects may also include the one or more Internet of Things (IoT) devices 112. The authoring and rendering device 102 may receive real-time IoT data from the one or more IoT devices 112.

The training module may further include an anchor specification corresponding to each of the set of views. In an embodiment, the anchor specification may include a spatial marker, an image marker or an object marker. The training module may further include a set of animation steps associated with the one or more real-world objects and the one or more training objects. In an embodiment, the set of animation steps may correspond to one or more steps to be performed for performing the operation. The training module may further include metadata corresponding to each of the set of animation steps.

The authoring and rendering device 102 may further receive a video of a real-world scenario of the equipment corresponding to the XR experience. The authoring and rendering device 102 may further detect a set of image frames in the video corresponding to a portion of the set of views based on the detection of the one or more real-world objects and the one or more training objects in the video. The authoring and rendering device 102 may further detect a set of image frames in the video corresponding to a portion of the set of views based on the detection of the one or more real-world objects and the one or more training objects in the video.

The authoring and rendering device 102 may further create a first set of three-dimensional (3D) views for each of the set of views and a second set of 3D views for each of the set of image frames using a 3D-modelling tool. The authoring and rendering device 102 may further generate a unified XR content package for the XR experience based on the first set of 3D views, the second set of 3D views and the anchor specification. To generate the unified XR content package, the authoring and rendering device 102 may determine a set of augmented views by augmenting the second set of 3D views with respect to a portion of the first set of 3D views corresponding to the portion of the set of views based on the anchor specification. Further, to generate the unified XR content package, the authoring and rendering device 102 may compile the set of augmented views, the first set of 3D views and the second set of 3D views, the set of animation steps associated with the one or more real-world objects and the one or more training objects and the metadata corresponding to each of the set of animation steps in the predefined sequence. In an embodiment, the unified XR content package may include a plurality of file formats that may be compatible with the plurality of viewing devices 114. The plurality of file formats may include, but is not limited to, a GL Transmission Format Binary (GLB) file format.

To compile the set of augmented views, the authoring and rendering device 102 may select an animation corresponding to each of the set of animation steps from a predefined library of animations. Further, to compile, the authoring and rendering device 102 may associate the metadata for each of the set of animation steps. In an embodiment, the metadata may describe the one or more steps to be performed by the user. The authoring and rendering device 102 may further store the unified XR content package on the server 118.

The authoring and rendering device 102 may further render the XR experience on one or more of the plurality of viewing devices 114 to provide assistance during the operation. In an embodiment, the real-time IoT data may also be rendered along with the XR experience indicating a real-time condition of the one or more IoT devices 112. To render the XR experience, the authoring and rendering device 102 may determine a compatible format from the plurality of file formats compatible with a corresponding client application of each of the one or more of the plurality of viewing devices 114. In an embodiment, the XR experience may be rendered based on execution of a corresponding file formats compatible with each of the one or more of the plurality of viewing devices 114.

The authoring and rendering device 102 may further receive a user query as an input by the user via the I/O device 108, requesting information corresponding to the one or more real-world objects and the one or more training objects being rendered while rendering the XR experience. The authoring and rendering device 102 may further receive a response to the user query from a generative AI model. In an embodiment, examples of the generative AI model may include, but are not limited to, a Generative Pre-trained Transformer (GPT), Bidirectional Encoder Representations from Transformer (BERT), CodeGen, etc. In an embodiment, the generative AI model may be trained based on a predefined specification data corresponding to the equipment, the one or more real-world objects and the one or more training objects. The authoring and rendering device 102 may further output the response to the user query along with the XR experience via the I/O device 108.

The authoring and rendering device 102 may further receive a user input via the I/O device 108 for modulating the rendering of the XR experience based on a selection of the one or more steps via an interactive interface of the I/O device 108. Thereafter, the authoring and rendering device 102 may modulate the rendering of the XR experience based on the user input.

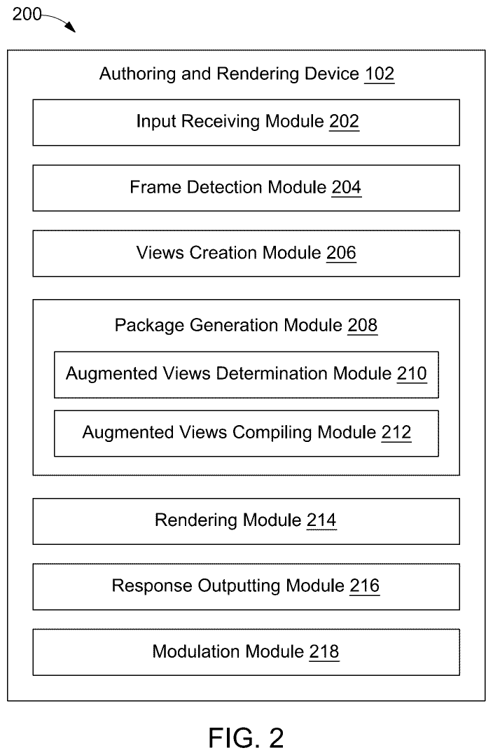

FIG. 2 illustrates a functional block diagram of the authoring and rendering device 102, in accordance with an embodiment of the present disclosure. FIG. 2 is explained in conjunction with FIG. 1. In an embodiment, the authoring and rendering device 102 may include an input receiving module 202, a frame detection module 204, a views creation module 206, a package generation module 208, a rendering module 214, a response outputting module 216, and a modulation module 218.

The input receiving module 202 may receive a training module for the XR experience. It should be noted that the training module may be provided by a user via the I/O device 108. In an embodiment, the training module may include a set of views arranged in a predefined sequence for performing the operation. It is to be noted that each of the set of views may correspond to a set of steps to be performed while performing the operation in real time. In an embodiment, each of the set of views may include one or more real-world objects and one or more training objects corresponding to the equipment. In an embodiment, the one or more real-world objects and the one or more training objects may also include the one or more IoT devices 112. The input receiving module 202 may also receive real-time IoT data from the one or more IoT devices 112.

In an exemplary embodiment, the input receiving module 202 is configured to integrate the training module into the XR experience. For instance, a technician tasked with disassembling and reassembling a complex machine, such as a pneumatic cylinder, may utilize augmented reality (AR) glasses to receive real-time visual guidance throughout the operation (e.g., disassembling and reassembling). The training module, which is provided by the technician via the I/O device 108, includes a set of views arranged in a predefined sequence corresponding to the operation of disassembly and assembly process. Each of the set of views within the training module may depict one or more real-world objects such as the pneumatic cylinder components and one or more training objects that correspond to the pneumatic cylinder. These training objects may include interactive elements that the technician engages with during the operation. Additionally, the one or more real-world and training objects may be integrated with IoT devices, such as sensors or actuators, that provide real-time data about the condition of the pneumatic cylinder. The input receiving module 202 is also configured to receive the real-time IoT data from the IoT devices to enhance the XR experience by incorporating live operational feedback into the training sequence. It is to be noted that this example should not be considered as limiting the experience to training alone. The experience may include a variety of use cases, including but not limited to job aids, guided instructions, training, inspections, other operational aids and so on.

The training module may further include an anchor specification corresponding to each of the set of views. In an embodiment, the anchor specification may include, but is not limited to, a spatial marker, an image marker, or an object marker. The training module may further include a set of animation steps associated with the one or more real-world objects and the one or more training objects. In an embodiment, the set of animation steps may correspond to one or more steps to be performed for performing the operation. The training module may further include metadata corresponding to each of the set of animation steps.

In continuation with the exemplary embodiment, the training module further includes an anchor specification for each of the set of views. For example, while the technician is disassembling the pneumatic cylinder using AR glasses, anchor specifications are employed to maintain the spatial consistency of the visual guidance within field of view. These anchor specifications may include various types of markers, such as spatial markers that align the AR content with the physical environment, image markers that recognize specific visuals, or object markers that attach the guidance to physical components of the pneumatic cylinder. Moreover, the training module includes the set of animation steps associated with the real-world and training objects. For instance, animations may illustrate the correct sequence of actions, such as “unscrewing bolts” or “positioning parts during the disassembly”. These animations are critical for guiding the technician through each step of the operation to ensure precision and reducing the likelihood of errors. Furthermore, the training module includes metadata corresponding to each of the set of animation steps. The metadata may include additional information, such as detailed descriptions of the tasks, safety precautions, or references to equipment specifications. For example, during the assembly phase, the metadata may also provide safety guidelines that might be used to alert the technician regarding the torque requirements for securing bolts or may provide warnings about potential misalignments.

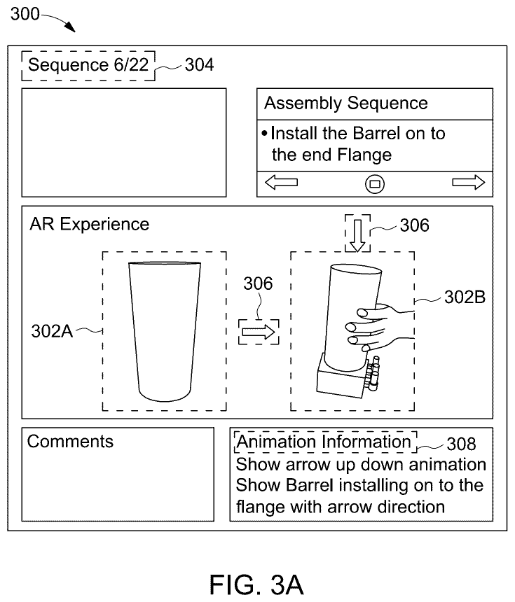

Referring now to FIGS. 3A and 3B, a training module 300 is illustrated, in accordance with an exemplary embodiment of the present disclosure. The training module 300 may include a set of views 302A-D that guides through a series of steps for performing an operation on a specific equipment. For instance, disassembling and reassembling of a complex machine, such as a pneumatic cylinder.

The set of views 302A-D are arranged in a predefined sequence 304, which shows the order in which the series of steps of the operation are to be executed. The predefined sequence 304 is to enhance the learning process or operational workflow which ensures that each step is logically linked to the previous one. In an embodiment, each of the set of views 302A-D may include one or more real-world objects. These are the actual objects present in the physical environment that the user interacts with during the operation (e.g., disassembling and reassembling). The set of views 302A-D may also include one or more training objects corresponding to the equipment (e.g., pneumatic cylinder).

The training module 300 also includes a set of animation steps 306 that visually represent the actions to be performed with the real-world and training objects. The animations may include actions such as moving, rotating, or assembling parts, providing a visual guide that simplifies complex procedures. These steps are crucial for tasks that require precise manual dexterity or understanding of spatial relationships among components. Each animation step 306 is accompanied by animation information 308, which serves as a descriptive layer that provides additional context and information about the step. The animation information 308 may include text descriptions and specifications relevant to the operation. In an embodiment, the operation involves both the disassembly and reassembly of the pneumatic cylinder. The system leverages extended reality (XR) experiences to guide users step-by-step through both processes using a combination of real-world and training objects, animation steps, and associated animation information, as illustrated in FIG. 3A and FIG. 3B.

Referring back to FIG. 2, the input receiving module 202 may further receive a video of a real-world scenario of the equipment corresponding to the XR experience. In an exemplary embodiment, the input receiving module 202 may receive a video stream of the real-world scenario that depicts the equipment (e.g., pneumatic cylinder) relevant to the XR experience. The video stream provides real-time visual data of the equipment as it is being interacted with or operated in a physical environment. For instance, if the XR experience involves training a technician to disassemble and reassemble the pneumatic cylinder, the video may capture the pneumatic cylinder and show various operational states and interactions. It is to be noted that this example should not be considered as limiting the experience to training alone. The experience may include a variety of use cases, including but not limited to job aids, guided instructions, training, inspections, and other operational aids.

For example, if the training module involves disassembling the pneumatic cylinder, the video might show the cylinder in its fully assembled state, highlight how it functions within the system, and demonstrate the correct techniques for disassembling the pneumatic cylinder. The real-world visual context is crucial, as it allows the technician to see practical applications of the steps they will perform.

Accordingly, the frame detection module 204 may detect a set of image frames in the video corresponding to a portion of the set of views based on the detection of the one or more real-world objects and the one or more training objects in the video. The frame detection module 204 analyzes the video stream received by the input receiving module 202. The frame detection module 204 may detect and extract specific image frames from the video that correspond to a subset of the set of views used in the XR experience. This process involves identifying portions of the video that match the real-world objects, and the training objects referenced in the XR content.

In accordance with the exemplary embodiment, the frame detection module 204 detects the set of image frames within the video stream that align with the portion of the set of views used in the XR experience. For instance, during the disassembly of the pneumatic cylinder, the frame detection module 204 analyzes the video stream captured in real-time to identify frames that depict the pneumatic cylinder, associated tools, or any IoT devices 112 involved in the operation.

The frame detection module 204 utilizes advanced algorithms to compare the video content with the set of views and corresponding objects specified in the XR training module. This includes detecting specific visual markers, shapes, or features that distinguish the one or more real-world objects and training objects, such as the components of the pneumatic cylinder and the tools needed for the disassembly. For example, as the technician progresses through the disassembly steps using AR glasses, the module identifies relevant frames where the cylinder's piston, end caps, or seals are visible and being manipulated.

By accurately mapping these frames to the set of views 302A-D of the training module 300, the frame detection module 204 ensures that the technician is receiving real-time visual feedback that corresponds precisely to their current step in the operation (e.g., disassembling and reassembling the pneumatic cylinder).

Thereafter, the views creation module 206 may create a first set of three-dimensional (3D) views for each of the set of views and a second set of 3D views for each of the set of image frames using a 3D-modelling tool. In an embodiment, this process involves defining the spatial relationships, textures, and geometric properties of the objects depicted in each of the set of views and the set of image frames. Each 3D view represents a virtual depiction of the real-world objects and the training objects as described in the training module. For example, for a machine assembly training XR experience, if the predefined view includes a top-down view of components of the machine assembly, the first set of 3D views would include detailed 3D models of each component, arranged according to their spatial layout and operational context. The second set of 3D views is generated based on the image frames detected from the real-world video data. This involves interpreting the 2D image data from the video and reconstructing it into 3D views that correspond to the detected real-world scenarios. The second set of 3D views provides a virtual representation of the real-world scenes captured in the video that enables accurate overlay and interaction within the XR environment.

In accordance with the exemplary embodiment, the views creation module 206 uses a 3D-modelling tool to generate both the first set of 3D views and the second set of 3D views for the XR experience. For instance, when training a technician for the disassembly and assembly of the pneumatic cylinder, the first set of 3D views is created by converting the set of views 302A-D present in the training module 300 into detailed 3D models. These models accurately depict the spatial relationships, textures, and geometric properties of the components of the pneumatic cylinder, such as pistons, seals, and screws, as outlined in the training module. For example, if the training module specifies a top-down view of the pneumatic cylinder's assembly, the first set of 3D views may include 3D models of each component, arranged in a manner that reflects their actual positioning and function within the assembly. Simultaneously, the views creation module 206 generates the second set of 3D views based on the image frames detected from the real-world video data, as identified by the frame detection module 204. For instance, as the technician uses AR glasses to view the pneumatic cylinder in real time, the video feed captures various stages of the cylinder being disassembled. The views creation module 206 then interprets these 2D video frames, reconstructing them into corresponding 3D views that represent the real-world scenes. These second set of 3D views enable a seamless overlay of the real-world objects and tools, like the cylinder components and the tools such as spanner and Allen key, within the XR environment. This dual layer of 3D views ensures that the XR experience not only guides the technician through each step but also accurately reflects the real-time interactions and conditions they are working under. It is to be noted that this example should not be considered as limiting the experience to training alone. The experience may include a variety of use cases, including but not limited to job aids, guided instructions, training, inspections, and other operational aids.

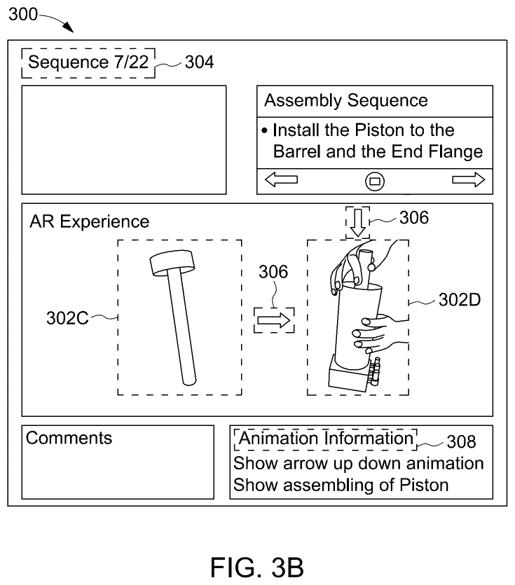

Referring now to FIG. 4, a three-dimensional (3D) view 400 of a training object 402 is illustrated, in accordance with an embodiment of the present disclosure. FIG. 4 shows a 3D view 400 that provides a virtual representation of a training object 402. The 3D view 400 is designed to provide a clear and interactive understanding of the training object 402 within the extended reality (XR) environment. The training object 402 is depicted as a detailed 3D model within the 3D view 400. The training object 402, not limited to the embodiment, may be any component or tool relevant to the training process, such as a machine part, assembly component, or equipment. The 3D view 400 presents the training object 402 from a specific angle or perspective that is chosen to highlight key aspects of the training object 402. It is to be noted that this example should not be considered as limiting the experience to training alone. The experience may include a variety of use cases, including but not limited to job aids, guided instructions, training, inspections, and other operational aids.

Referring back to FIG. 2, the package generation module 208 may generate a unified XR content package for the XR experience based on the first set of 3D views, the second set of 3D views and the anchor specification. The first set of 3D views includes detailed 3D models created for each of the initial views in the XR experience. These models are important for depicting the primary elements or objects that users will interact with or observe. The second set of 3D views consists of 3D models derived from video frames of real-world scenarios, providing additional contextual or supplementary views relevant to the XR experience. The anchor specification includes spatial markers, image markers, or object markers used to align and synchronize the 3D views with real-world references. The anchor specification ensures that the virtual content is accurately placed and interacts correctly with the real-world environment.

For instance, an XR training module for assembling the pneumatic cylinder involves multiple steps where users need to interact with various components of the pneumatic cylinder. The first set of 3D views includes detailed 3D models of individual machine parts like gears, bolts, and control panels. The second set of 3D views provides supplementary 3D models based on video frames showing the actual assembly process, including how components fit together in real-time. The anchor specification utilizes spatial markers to ensure the virtual components align with their real-world counterparts. The package combines these elements into a content format (e.g., GLB file) that may be rendered by VR or AR devices to provide users with a complete and interactive extended reality experience.

The package generation module 208 may include an augmented views determination module 210 and an augmented views compiling module 212. To generate the unified XR content package, the augmented views determination module 210 may determine a set of augmented views by augmenting the second set of 3D views with respect to a portion of the first set of 3D views corresponding to the portion of the set of views based on the anchor specification. The package generation module 208 uses the anchor specification to overlay or blend the second set of 3D views (derived from video frames) onto the corresponding portions of the first set of 3D views.

In accordance with the exemplary embodiment, the package generation module 208 employs the augmented views determination module 210 to generate augmented views by enhancing the second set of 3D views with specific portions of the first set of 3D views based on the anchor specification. For example, during the disassembly and assembly training of the pneumatic cylinder using AR glasses, the augmented views determination module 210 uses an anchor specification, such as a spatial marker, to align the augmented views accurately. The augmented views determination module 210 overlays the real-world 3D views derived from the video frames onto the instructional 3D models of the pneumatic cylinder. Suppose the anchor specification identifies a specific spatial marker on the cylinder's base. The augmented views determination module 210 may use this marker to accurately position the real-time 3D view of the partially disassembled piston in alignment with the corresponding instructional view from the first set of 3D views. It is to be noted that this example should not be considered as limiting the experience to training alone. The experience may include a variety of use cases, including but not limited to job aids, guided instructions, training, inspections, and other operational aids.

Further, the augmented views compiling module 212 may compile the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package. In an embodiment, the unified XR content package may include a plurality of file formats that may be compatible with the plurality of viewing devices 114. The plurality of file formats may include, but is not limited to, a GL Transmission Format Binary (GLB) file format. The augmented views compiling module 212 integrates the augmented views with the static and dynamic 3D models, further applies animation steps, and attaches metadata that provides context and instructions. The final package is designed to be compatible with a range of viewing devices such as AR glasses, smartphones, or tablets, and includes multiple file formats, such as GLB, for flexibility in rendering. For instance, during the maintenance training of a pneumatic cylinder, the augmented views compiling module 212 compiles the augmented views that visually combine real-time 3D data of the cylinder with instructional 3D models from the training module. It is to be noted that this example should not be considered as limiting the experience to training alone. The experience may include a variety of use cases, including but not limited to job aids, guided instructions, training, inspections, and other operational aids.

Additionally, the augmented views compiling module 212 includes a set of animation steps that demonstrate specific actions required for the operation, such as the “precise motion of an Allen key to remove screws”. Each animation step is enhanced with metadata that provides detailed descriptions, safety warnings, or step-by-step guidance, ensuring that the user understands the actions to be performed in each phase of the operation. By providing the XR content package in a range of formats, the package generation module 208 ensures that the training module may be deployed on a range of platforms.

To compile the set of augmented views, the augmented views compiling module 212 may select an animation corresponding to each of the set of animation steps from a predefined library of animations. In an embodiment, the augmented views compiling module 212 first accesses a predefined library of animations tailored for industrial machine maintenance. The library includes a variety of animations depicting common maintenance tasks, such as disassembling machine components, cleaning parts, replacing worn-out parts, and reassembling the machine. For a specific maintenance task, such as replacing a worn-out seal, the module selects an animation that visually demonstrates the step-by-step procedure for removing and installing the new gear. The animation shows the exact movements and tools required for the task. For instance, when conducting a maintenance procedure on the pneumatic cylinder, such as replacing a worn-out seal, the augmented views compiling module 212 selects a corresponding animation from the library that illustrates the correct sequence of actions to replace the worn-out seal. The animation may demonstrate the disassembly of the cylinder and highlight the exact location and method to remove the seal, followed by the steps to properly install a new seal and reassemble the cylinder. Each animation includes detailed visual indications, such as the correct positioning of tools (like spanners and Allen keys), the direction of movements, and the specific order of tasks, which are crucial for accurately performing the maintenance procedure. By showing these animations in the augmented views, the XR experience provides a comprehensive guide for technicians to visualize or learn or follow along with the precise steps needed for the operation.

The augmented views compiling module 212 may further associate the metadata for each of the set of animation steps. In an embodiment, the metadata may describe the one or more steps to be performed by the user. Each animation step selected from the library is associated with relevant metadata that provides additional context and instructions. The metadata includes text descriptions, tips, warnings, and specifications related to the maintenance task. For the gear replacement task, the metadata might include details such as the type of gear to be used, the torque specifications for tightening bolts, and safety precautions to follow. This ensures that users have all the information to perform the task correctly and safely. The augmented views compiling module 212 integrates the selected animations and associated metadata into the unified XR content package. This package combines the augmented views (which overlay live-action 3D models onto static 3D models), the selected animations, and the metadata in a structured format. The final XR content package includes the augmented views showing the gear replacement process, animations demonstrating each step of the procedure, and metadata providing detailed instructions.

Upon compiling, the augmented views compiling module 212 may further store the unified XR content package on the server 118. In an embodiment, technicians and maintenance staff may access the unified XR content package on the server 118, download the XR content package to their devices, and use it for on-the-job experience, including but not limited to job aids, guided instructions, training, inspections, and other operational aids.

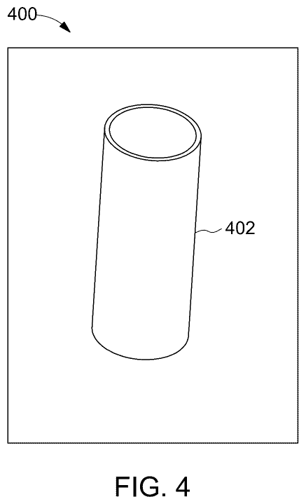

Referring now to FIG. 5, a Graphic User Interface (GUI) 500 of an XR authoring application for authoring extended reality enabled on the authoring and rendering device 102 of FIG. 1 is illustrated, in accordance with an exemplary embodiment of the present disclosure. The GUI 500 is enabled on the authoring and rendering device 102, as shown in FIG. 1. The GUI 500 enables user interaction with the XR authoring application and provides options for configuring various aspects of the XR content. The GUI 500 may include a first display area 502. The first display area 502 is dedicated to selecting the type of anchoring to be used in the XR experience. Anchoring types determine how virtual objects or annotations are positioned and aligned with real-world objects or locations within the XR environment. For example, users may choose from various anchoring methods such as spatial markers, image markers, or object markers. Spatial markers might include predefined symbols or shapes placed in the real world to anchor virtual content, while image markers involve specific images recognized by the authoring and rendering device 102 to trigger and position virtual elements. The first display area 502 may include dropdown menus for different anchoring types. Visual previews or descriptions of each anchoring type is also displayed in the first display area 502 to assist users in making their selection.

The GUI 500 may further include a second display area 504. The second display area 504 allows users to select the viewing devices that may be used to render the XR experience. This enables the configuration of the XR content compatibility with a range of viewing devices. Users may choose a viewing device from the range of viewing devices, including virtual reality (VR) headsets, augmented reality (AR) glasses, smart devices, or other XR-compatible hardware. The selection may involve checkboxes, a list of device types, or a visual representation of supported devices.

The GUI 500 may further include an apply button 506 and a cancel button 508. The apply button 506 is used to confirm and apply the selected settings and configurations made in the first display area 502 and the second display area 504. Clicking the apply button 506 finalizes the choices and updates the XR authoring project accordingly. The cancel button 508 allows users to discard any changes or selections made in the current session. Clicking the cancel button 508 reverts any modifications and returns the user to the previous state or screen without applying the changes.

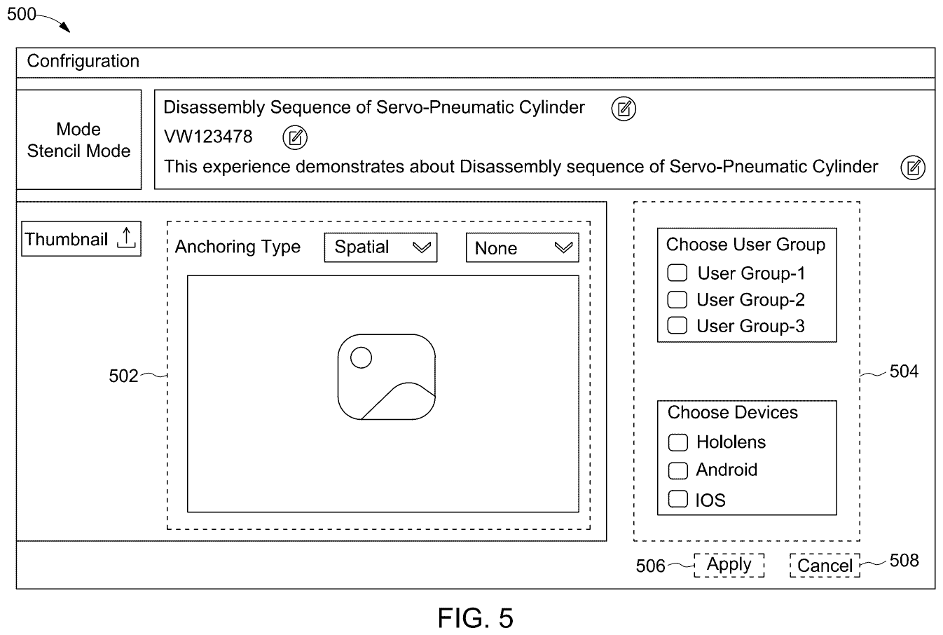

Referring now to FIG. 6, a GUI 600 of the XR authoring application for authoring the extended reality, continuing from FIG. 5, in accordance with an exemplary embodiment of the present disclosure. The GUI 600 is presented as the continuation of the GUI 500 after the user has selected the apply button 506. The GUI 600 may include a first display area 602 showcases a three-dimensional (3D) representation of a training object, specifically a pneumatic cylinder. The first display area 602 provides a visual representation of the object that users will interact with in the XR experience. For instance, the 3D pneumatic cylinder model is rendered with detailed textures and accurate dimensions to assist users in understanding its structure and components. Users can manipulate the 3D model to view different angles and details. The first display area 602 may include interactive controls for rotating, zooming, and panning the 3D model. Options to highlight or isolate specific parts of the pneumatic cylinder may also be available. The GUI 600 may further include a second display area 604. The second display area 604 displays a set of 3D tools that may be used in conjunction with the 3D training object as shown in the first display area 602 to perform a disassembly operation. The second display area allows users to select and view the tools for the task. Tools such as an Allan key and spanner are represented in 3D, showing their design and how they will interact with the pneumatic cylinder.

The GUI 600 may further include a third display area 606. The third display area 606 presents the hierarchy of components, including the 3D training object and 3D tools. The third display area 606 provides an organized view of how different elements are structured and related within the XR experience. The third display area 606 may feature a tree structure or list format displaying the components and their hierarchical relationships. Users may expand or collapse sections to view or edit specific parts of the hierarchy.

The GUI 600 may further include a fourth display area 608. The fourth display area 608 includes a panel for defining the sequence of steps required to perform the disassembly operation on the pneumatic cylinder. The fourth display area 608 enables users to outline and organize the procedural steps. Users can add, edit, or rearrange steps in the sequence and specify the actions to be performed with the pneumatic cylinder and tools. For instance, the sequence may include steps like “Remove retaining screw,” “Use spanner to loosen bolt,” and “Disassemble pneumatic cylinder.” This panel may offer controls for adding new steps, editing existing ones, and removing steps may be provided. Further, the GUI 600 may include a fifth display area 610. The fifth display area 610 features a dropdown menu for selecting a media type, such as a video, to be incorporated into the XR experience. This media will complement the disassembly operation by providing additional context or instructions. Users can choose from available media files, such as instructional videos or demonstrations, that align with the disassembly steps. The selected media will be integrated into the XR content to enhance the user's understanding. The dropdown menu allows users to browse and select media files.

The GUI 600 may further include an import button 612, a save button 614, and a publish button 616. The import button 612 allows users to import additional resources or files into the XR authoring application. This may include importing 3D models, animations, or other relevant data. The save button 614 enables users to save their progress and configurations in the XR authoring application. Clicking this button stores the current state of the project, including any modifications made in the GUI 600. The publish button 616 allows users to finalize and publish the XR content once it is complete. This action prepares the content for deployment and distribution.

Referring back to FIG. 2, the rendering module 214 may further render the XR experience on one or more of the plurality of viewing devices to provide assistance during the operation. In an embodiment, the real-time IOT data may also be rendered along with the XR experience indicating a real-time condition of the one or more IOT devices 112. To render the XR experience, the rendering module 214 may determine a compatible format from the plurality of file formats compatible with a corresponding client application of each of the one or more of the plurality of viewing devices 114.

In an embodiment, the XR experience may be rendered based on execution of a corresponding file format from the plurality of file formats compatible with each of the one or more of the plurality of viewing devices 114. The user has authored the XR content through the GUI 600, such as defining the sequence of steps for disassembling and assembling the pneumatic cylinder as per the exemplary embodiment. The 3D models of the pneumatic cylinder and related tools, as well as instructional media, have been selected and organized. The rendering module 214 retrieves the XR content package from the server 118. The package includes detailed 3D views of the pneumatic cylinder, associated tools, animation sequences, and metadata outlining the steps for disassembly and assembly. The rendering module 214 determines the appropriate file format for each viewing device 114 based on its compatibility. This ensures that the XR experience is correctly rendered on each of the plurality of viewing device 114, such as a Virtual Reality (VR) headset, a pair of Augmented Reality (AR) glasses, a smart device, and a Web Extended Reality (WebXR)-enabled platform. In an embodiment the WebXR allow users to access and interact with the XR experience via a web browser on desktop devices. WebXR is a web-based standard that supports rendering both the augmented reality (AR) and the virtual reality (VR) experiences directly through compatible web browsers or Application Programming Interface (APIs) without the need for dedicated hardware such as the AR glasses or the VR headsets. Users wearing VR headsets or AR glasses are presented with an immersive XR environment. In the case of VR, they are fully immersed in a virtual workshop where they may interact with a 3D model such as the pneumatic cylinder and tools as per the exemplary embodiment. In accordance with the exemplary embodiment, in AR, the pneumatic cylinder and tools are overlaid onto the real-world environment. The XR experience guides users through the disassembly steps. The 3D pneumatic cylinder in the GUI 600 is animated to show actions such as loosening bolts, removing components, and using specific tools. Instructional media, such as videos, provide additional guidance. If IoT devices are used to monitor the real-world equipment, their real-time data is integrated into the XR experience. For example, sensors might show current operational status or alert users to any issues during the disassembly. After disassembly, users proceed to the assembly process. The XR experience switches to showing how the pneumatic cylinder components should be reassembled. The animation steps are updated to reflect the assembly sequence, with the 3D views of the pneumatic cylinder and tools guiding users through each step. For example, a technician uses an AR headset to disassemble a pneumatic cylinder in a manufacturing plant. The AR headset overlays the 3D pneumatic cylinder and tools onto the real-world machine. The XR experience guides the technician through each step, displaying animations of how to use the tools and which parts to remove. As the technician works, real-time data from IoT sensors provides feedback on the equipment's status, ensuring that all steps are performed correctly. For example, if the technician works on a central processing unit (CPU), real-time IoT data related to a fan present in the CPU may be fetched by an IoT sensor and provided to the authoring and rendering device 102 and the real-time IOT data may also be rendered along with the XR experience indicating a real-time condition of the fan. Once the disassembly is complete, the XR system switches to assembly mode, guiding the technician through reassembling the pneumatic cylinder with the same level of detail and support.

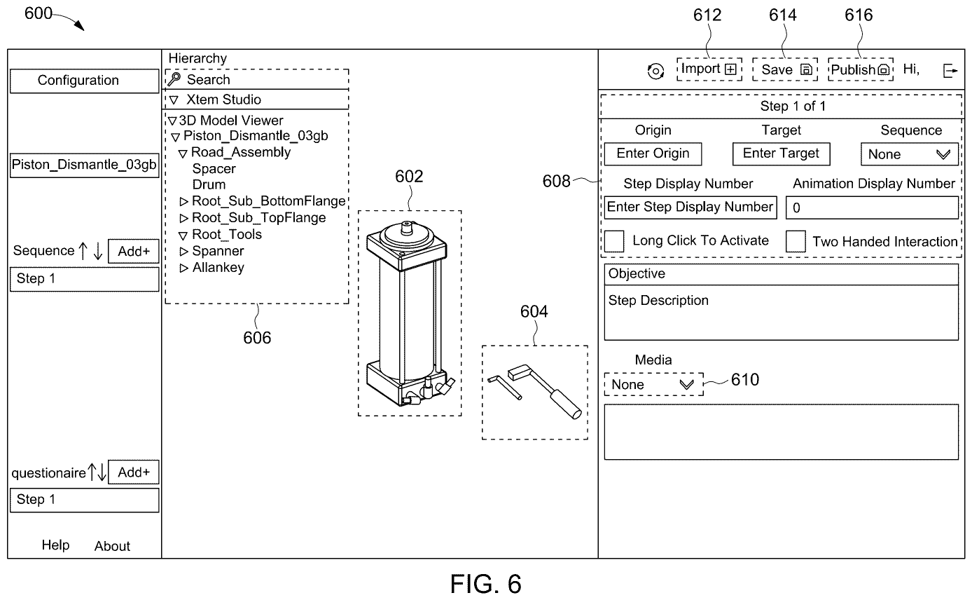

Referring now to FIG. 7, an exemplary deployment scenario 700 depicting rendering of the XR experience authored in FIG. 5 and FIG. 6 on the AR device 114C is illustrated, in accordance with an embodiment of the present disclosure. In the exemplary deployment scenario 700, the user 702 is depicted wearing the AR device 114C, which is specifically illustrated as a HoloLens. The AR device 114C is worn on head of the user to provide an immersive overlay of digital content onto the real-world environment. The AR device 114C projects the XR content into a field of view of the user 702. The XR content includes 3D models, animations, and instructional media related to the experience, such as an operation to be performed on an equipment (e.g., disassembly and assembly of the pneumatic cylinder).

The exemplary deployment scenario 700 includes a physical table 706 (i.e., a real-world object) placed in the real-world environment and serves as an anchor reference for the XR experience. The physical table 706 serves as the focal point where the XR experience is anchored and interacted with. On or around the table 706, the XR content is rendered, allowing the user to view and manipulate the 3D models of the pneumatic cylinder and tools in the context of the real-world setup. For example, the physical pneumatic cylinder and tools might be placed on the physical table 706, and the AR device 114C overlays digital instructions and animations on these real objects to guide the user through the disassembly or assembly process of the pneumatic cylinder. The AR device 114C projects a 3D model of the pneumatic cylinder onto the table 706. The 3D model may appear to be physically present on the table, integrated with the real-world environment. The user 702 may see step-by-step animations showing how to disassemble or assemble the pneumatic cylinder. Thus, the exemplary deployment scenario 700 depicts how the extended reality (XR) experience authored in FIG. 5 and FIG. 6 may be rendered on the AR device 114C to assist in an operation performed on an equipment.

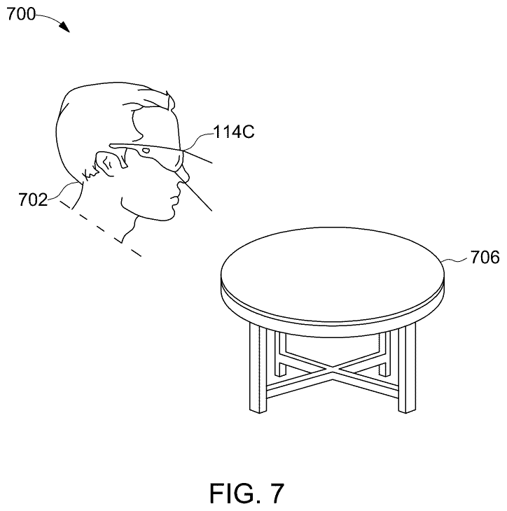

Referring now to FIG. 8A, a GUI 800 of a first client application enabled on the AR device 114C of FIG. 7 is illustrated, in accordance with an exemplary embodiment of the present disclosure. The GUI 800 provides a visual representation of how the XR experience is rendered and interacted with on the AR device 114C. It is to be noted that the XR experience should not be considered as limiting the experience to training alone. The experience may include a variety of use cases, including but not limited to job aids, guided instructions, training, inspections, and other operational aids. As shown in FIG. 8A, the XR experience is related to assembling and disassembling a pneumatic cylinder. The GUI 800 includes a first display area 802. The first display area 802 showcases the 3D model of the pneumatic cylinder, which is previously anchored and configured in the GUI 600 of FIG. 6. In this AR interface, the pneumatic cylinder appears overlaid on the physical table 706, integrated with the real-world environment. The GUI 800 may further include a second display area 804. The second display area 804 displays 3D models of tools, such as an Allen key and spanner, which are needed for the disassembly process. These tools are also overlaid on the physical table 706. The tools appear in the AR environment as if they are physically present on the table 706.

In an exemplary scenario, a technician wearing the AR device 114C may view the GUI 800 on the HoloLens. The pneumatic cylinder and tools may be displayed on the physical table 706 as detailed 3D models. The technician may interact with the GUI 800 to rotate the pneumatic cylinder model, view detailed parts, and see how the tools are used in the disassembly process.

Referring now to FIG. 8B, the GUI 800 of the first client application enabled on the AR device 114C, continuing from FIG. 8A, is illustrated, in accordance with the exemplary embodiment of the present disclosure. The FIG. 8B shows how the AR environment dynamically updates to depict interactions between the tools and the pneumatic cylinder during the disassembly process. As shown in FIG. 8B, the GUI 800 includes a first display area 806, a second display area 808A, and a third display area 808B.

The first display area 806 continues to render the 3D model of the pneumatic cylinder, now actively interacting with the spanner, as depicted in the second display area 808A. The interface shows the pneumatic cylinder with visual animations that demonstrate how the spanner is used to disassemble specific components of the pneumatic cylinder. The GUI 800 may include step-by-step visual guides, such as highlighted bolts or animated rotations which indicate where the spanner should be used. The real-time animation assists the user in understanding the precise movements and placements required for the disassembly. The third display area 808B renders the Allen Key, which is placed on the table 706 as part of the AR environment. This static representation allows the user to see the next tool that will be used in the sequence of operations.

In an exemplary scenario, a technician wearing the AR device 114C views the GUI 800 on the AR device 114C as they proceed with the disassembly of the pneumatic cylinder. The GUI 800 clearly shows the spanner in action and engaging with the pneumatic cylinder and provides animations on the correct technique and sequence of actions. Meanwhile, the Allen Key is placed on the table within the AR view, ready for the next step.

Referring now to FIG. 8C, the GUI 800 of the first client application enabled on the AR device 114C, continuing from FIG. 8B, is illustrated, in accordance with the exemplary embodiment of the present disclosure. As shown in FIG. 8C, the GUI 800 presents an updated state of the AR environment where the pneumatic cylinder is partially disassembled, demonstrating the interaction with the Allen Key, while the spanner is set aside on the table. The GUI 800 serves to guide the user through the next steps of the disassembly process. As shown in FIG. 8C, the GUI 800 includes a first display area 810 and a second display area 812.

The first display area 810 renders the 3D model of the pneumatic cylinder, now in a partially disassembled state. The GUI 800 specifically highlights the interaction between the pneumatic cylinder and the Allen Key and shows how the Allen Key is used to remove or adjust specific components, such as bolts or screws, that are integral to the disassembly process. This area includes animations that illustrate the correct application of the Allen Key to the pneumatic cylinder. The animation guides the user through each precise movement and ensures that they may replicate these actions in the physical environment. The second display area 812 shows the spanner now placed on the table 706 within the AR environment. The positioning of the spanner on the table visually communicates that its use is currently paused, while the focus shifts to the interaction of the Allen Key with the pneumatic cylinder.

Referring now to FIG. 8D, the GUI 800 of the first client application enabled on the AR device 114C in conjunction with FIGS. 8A, 8B and 8C is illustrated, in accordance with the exemplary embodiment of the present disclosure. The GUI 800 provides a visual and textual guide to support the disassembly process which combines video instructions and written text to ensure a comprehensive understanding of the procedure to perform the operation. As shown in FIG. 8D, the GUI 800 may include a first display area 814 and a second display area 816.

The first display area 814 is dedicated to rendering a video that visually demonstrates the sets of the operation such as, but not limited to, disassembling. The video rendered on the first display area 814 may depict a real-world scenario or a detailed simulation of the pneumatic cylinder disassembly process and shows each step as it should be performed. The inclusion of the video serves as an additional layer of instruction, providing a dynamic and easy-to-follow visual guide. This ensures that users may learn or closely follow along and match their actions with those demonstrated in the video, reducing the likelihood of errors during the operation.

The second display area 816 displays metadata in form of written text outlining the predefined sequence of steps required to perform the disassembly. The displayed written text may serve as a static reference that may complement the video rendered on the first display area 814, detailing each step in a clear and concise manner. For example, written text might include instructions such as “Insert the Allen Key into the bolt located at the top of the pneumatic cylinder” or “Rotate the Allen Key clockwise to loosen the bolt.”

In an exemplary scenario, a technician using the AR device 114C views the GUI 800 while performing the disassembly of a pneumatic cylinder. As the technician progresses through the task, they may watch the video in the first display area 814, which shows each disassembly step in real-time. Simultaneously, the technician may refer to the written instructions in the second display area 816 to ensure they are following the correct sequence. In an embodiment, the Extended Reality (XR) content described in FIG. 7, FIG. 8A, FIG. 8B, FIG. 8C and FIG. 8D for AR devices may similarly be adapted and deployed for Virtual Reality (VR) and WebXR platforms.

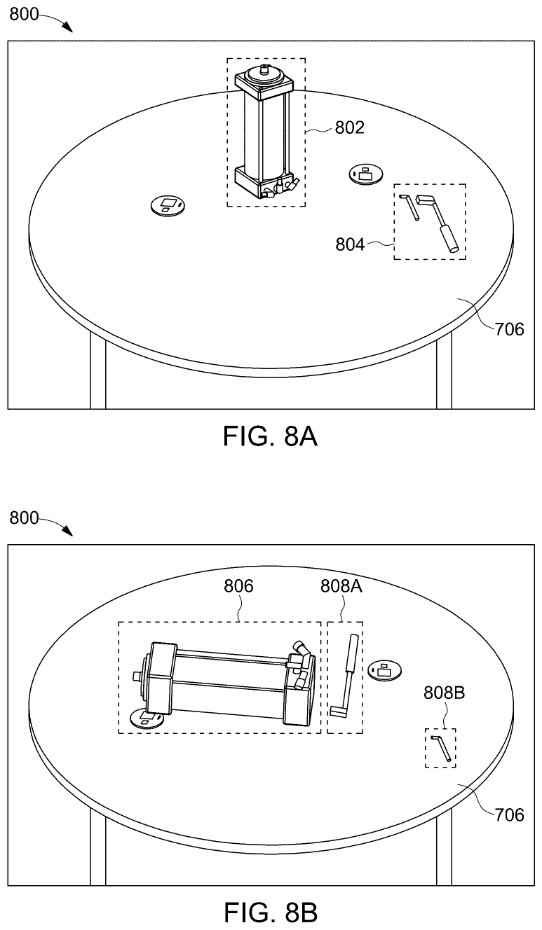

Referring now to FIG. 9, an exemplary deployment scenario 900 depicting rendering of the XR experience authored in FIG. 5 and FIG. 6 on the smart device 114B is illustrated, in accordance with an embodiment of the present disclosure. In this embodiment, the smart device 114B is specifically illustrated as a smartphone. The deployment scenario 900 demonstrates how the XR content may be utilized on portable smart devices, thereby offering a flexible and accessible means for users to engage with the XR experience in real-world settings.

The exemplary deployment scenario 900 features the user 702 actively engaging with the XR experience through the smart device 114B, which is a smartphone. The user 702 is shown holding the smart device 114B in a comfortable, ergonomic manner, which allows the user 702 to view and interact with the rendered XR content seamlessly.

The XR experience through the smart device 114B is depicted as being rendered on the physical table 706 (i.e., a real-world object) in front of the user 702. This spatial placement allows the XR content to be anchored in a real-world context, thereby enhancing the user perception of the virtual elements as part of their immediate environment. The smartphone display shows the rendered XR content, potentially overlaid with interactive buttons, controls, or annotations that guide the user through the procedure. The XR content may include 3D models, animations, and instructional media related to the task, such as, but not limited to, an operation to be performed on an equipment (e.g., disassembly and assembly of the pneumatic cylinder). The interface of the smart device 114B is designed to be intuitive by leveraging touch gestures and device movements (e.g., tilting, rotating) for interacting with the XR elements. Thus, the exemplary deployment scenario 900 depicts how the extended reality (XR) experience authored in FIG. 5 and FIG. 6 may be rendered on the smart device 114B to assist in an operation performed on an equipment.

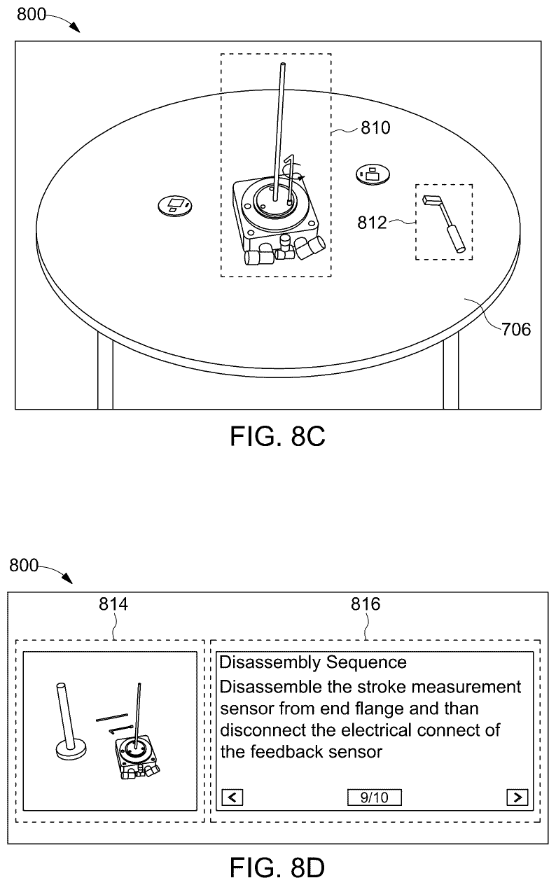

Referring now to FIG. 10A, a GUI 1000 of a second client application enabled on the smart device 114B of FIG. 9 is illustrated, in accordance with an exemplary embodiment of the present disclosure. The GUI 1000 provides an interactive display for guiding the user through an XR experience. It is to be noted that the XR experience should not be considered as limiting the experience to training alone. The experience may include a variety of use cases, including but not limited to job aids, guided instructions, training, inspections, and other operational aids. As shown in FIG. 10A, the XR experience is related to disassembling a pneumatic cylinder.

The GUI 1000 may include a first display area 1002, a second display area 1004, and a third display area 1006. The first display area 1002 prominently shows a 3D model of the pneumatic cylinder. The first display area 1002 provides a detailed, interactive view of the pneumatic cylinder, allowing users to rotate, zoom, and examine the component from various angles. The 3D visualization helps users understand the structure and key features of the pneumatic cylinder that are relevant for the disassembly process. Users can interact with the pneumatic cylinder model directly on the screen of the smart device 114B. For instance, tapping on specific parts of the pneumatic cylinder might provide additional information or highlight components that need attention during disassembly. This interactivity enhances the ability of the user to familiarize themselves with the part and its configuration.

The second display area 1004 showcases the tools required for the disassembly operation, specifically an Allen key and a spanner. The second display area 1004 provides images or 3D models of these tools, which are important for completing the task. The second display area 1004 may include labels or descriptions for each tool, explaining its function and how it should be used in conjunction with the pneumatic cylinder. Users can learn about the tools' specifics, such as their sizes or types, which helps in ensuring that the correct tools are used for the disassembly procedure.

The third display area 1006 describes the objective of the current step in the disassembly process. The third display area 1006 could include a brief explanation of what needs to be achieved during this particular phase of the operation. The objective description may provide instructions on how to use the tools shown in the second display area 1004, or it might explain the specific actions required to proceed with the disassembly of the pneumatic cylinder. Clear and concise guidance ensures that users understand the purpose of each step and can learn or follow the procedure effectively.

Referring now to FIG. 10B, the GUI 1000 of the second client application enabled on the smart device 114B, continuing to FIG. 10A, is illustrated, in accordance with an exemplary embodiment of the present disclosure. As shown in FIG. 10B, the GUI 1000 includes a first display area 1008 and a second display area 1010.

The first display area 1008 presents a visual representation of the pneumatic cylinder in its partially disassembled state. The visual representation includes the Allen key interacting with the pneumatic cylinder, highlighting how the tool is being used to perform specific disassembly tasks. The partial disassembly view helps users see the current state of the pneumatic cylinder and understand the effects of using the Allen key on different components. The first display area 1008 might include close-ups of the interaction points where the Allen key is applied, providing clarity on the exact locations and actions needed for the disassembly process.

The second display area 1010 provides textual instructions for the disassembly sequence. For instance, it might include a step such as “Remove the 3 screws from the stroke measurement sensor with Allen key.” The second display area 1010 offers clear and concise instructions on the specific actions users need to take to perform an operation (e.g., assembling and disassembling) on an equipment (e.g., pneumatic cylinder). The description is detailed enough to guide users through each step, including the tools required and the exact parts of the pneumatic cylinder to be worked on. This ensures that users follow a systematic approach to disassembly, reducing the risk of errors and improving the efficiency of the task. The GUI 1000 might include navigation controls or progress indicators that show which steps have been completed and what remains to be done. This feature helps users track their progress through the disassembly process. In an embodiment, the Extended Reality (XR) content described in FIG. 9, FIG. 10A, and FIG. 10B for smart devices may similarly be adapted and deployed for Virtual Reality (VR) and WebXR platforms.

Referring back to FIG. 2, the input receiving module 202 may further receive a user query as an input by the user via the I/O device 108, requesting information corresponding to the one or more real-word objects and the one or more training objects being rendered while rendering the XR experience. The input receiving module 202 may further receive a response to the user query from a generative AI model. In an embodiment, the generative AI model may be trained based on a predefined specification data corresponding to the equipment, the one or more real-world objects and the one or more training objects. The response outputting module 216 may output the response to the user query along with the XR experience.

In an exemplary embodiment, the input receiving module 202 and the response outputting module 216 together enhance the XR experience by integrating interactive queries and AI-generated responses. The input receiving module 202 is configured to accept user query input through the I/O device 108. For instance, during an XR training session for disassembling a complex industrial machine, a technician may have questions about specific components or steps. The user can input these queries using voice commands, text input, or other interaction methods supported by the I/O device. The input receiving module 202 forwards the user queries to a generative AI model. The generative AI model is trained on a comprehensive dataset that includes predefined specification data related to the equipment, real-world objects, and training objects depicted in the XR experience. It is to be noted that this example should not be considered as limiting the experience to training alone. The experience may include a variety of use cases, including but not limited to job aids, guided instructions, training, inspections, and other operational aids. For example, if the XR experience involves a pneumatic cylinder, the AI model would be familiar with technical specifications, maintenance procedures, and common issues related to that equipment. The generative AI model processes the query by leveraging its training to generate a relevant and accurate response. This could include detailed explanations, troubleshooting steps, or additional instructions corresponding to the user queries.

Once the AI model generates a response, the response outputting module 216 integrates this information into the ongoing XR experience. The response is displayed or rendered in conjunction with the XR content thus ensuring that the user receives real-time, contextually relevant answers. For instance, if a technician asks, “how to replace a specific component?”, during the XR training, the response could provide step-by-step instructions or additional tips displayed on the AR glasses or within the VR environment.

In accordance with the exemplary embodiment, in a training module for disassembling and reassembling the pneumatic cylinder, a technician working with AR glasses might encounter a situation where they need clarification on how to handle a particular part. They could ask, “How do I safely remove the shaft?” The input receiving module 202 captures this query and sends it to the generative AI model. Based on its training data, the AI model responds with a detailed explanation, including safety precautions, required tools, and the correct procedure. The response outputting module 216 then displays this information directly within the XR experience, either as an overlay in the field of view of the technician or as a voice-guided instruction. By incorporating AI-generated responses into the XR experience, this embodiment provides users with dynamic, context-sensitive support and enhance the training process and improving overall engagement and learning outcomes. It is to be noted that this embodiment should not be considered as limiting the experience to training alone. The experience may include a variety of use cases, including but not limited to job aids, guided instructions, training, inspections, and other operational aids.

Further, the input receiving module 202 may receive a user input via the I/O device 108 for modulating the rendering of the XR experience based on a selection of the one or more steps via an interactive interface of the I/O device 108. The modulation module 218 may further modulate the rendering of the XR experience based on the user input. In the context of a training module for maintaining an industrial machine (e.g., disassembling and reassembling a pneumatic cylinder), the input receiving module 202 may allow the technician to interact with the XR experience through an I/O device 108, such as a touchscreen tablet or voice commands via AR glasses. For instance, if the technician identifies that a certain step, like cleaning a part that was already cleaned, is unrequired, they can choose to skip this step or move the sequence forward directly to the next relevant action. Conversely, if the technician needs to revisit a previous step, such as re-checking the alignment of components, they can move the rendering backward. The modulation module 218 may then adjust the XR experience accordingly by dynamically updating the visual guidance to reflect the selected steps. This flexibility ensures that the XR experience is more aligned with the real-time needs and pace of the user.

It should be noted that all such aforementioned modules 202-218 may be represented as a single module or a combination of different modules. Further, as will be appreciated by those skilled in the art, each of the modules 202-218 may reside, in whole or in parts, on one device or multiple devices in communication with each other. In some embodiments, each of the modules 202-218 may be implemented as dedicated hardware circuit comprising custom application-specific integrated circuit (ASIC) or gate arrays, off-the-shelf semiconductors such as logic chips, transistors, or other discrete components. Each of the modules 202-218 may also be implemented in a programmable hardware device such as a field programmable gate array (FPGA), programmable array logic, programmable logic device, and so forth. Alternatively, each of the modules 202-218 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for authoring and rendering extended reality (XR) experience. For example, the exemplary system 100 and the associated processor 104 may author and render extended reality for the XR experience by the processes discussed herein. In particular, as will be appreciated by those of ordinary skill in the art, control logic and/or automated routines for performing the techniques and steps described herein may be implemented by the system 100 and the associated authoring and rendering device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

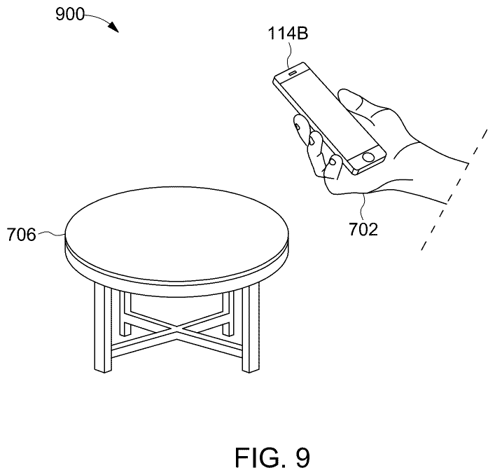

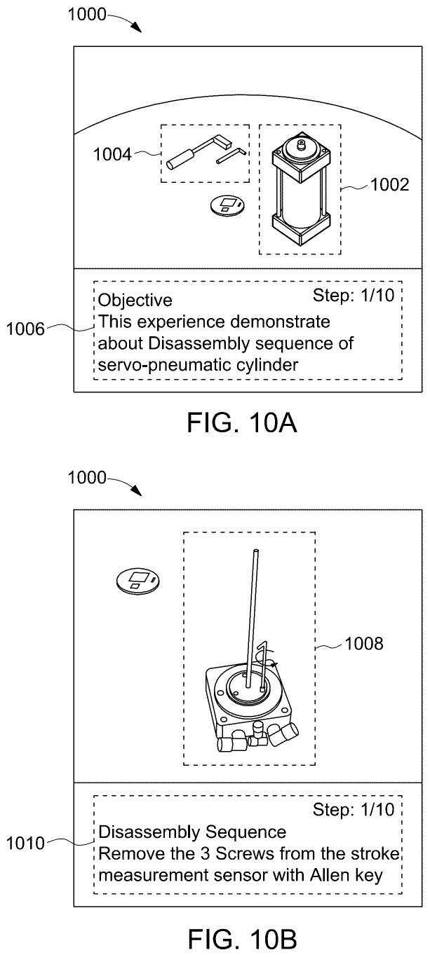

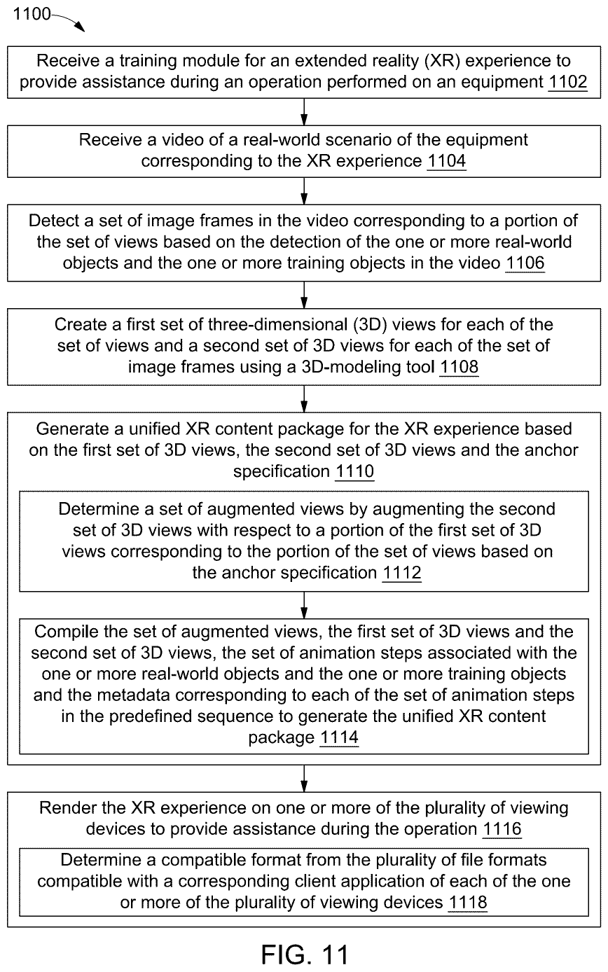

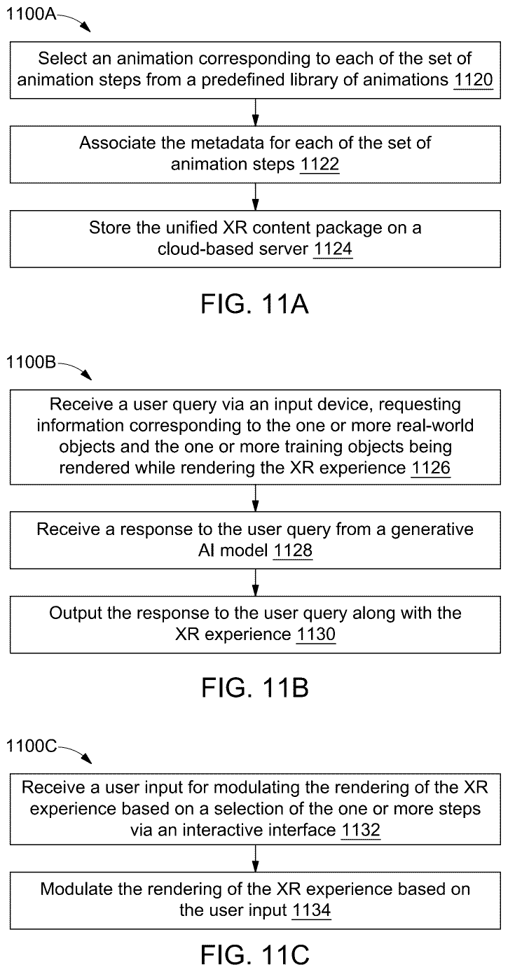

Referring now to FIG. 11, a flow diagram 1100 of a method of authoring and rendering extended reality (XR) experience to provide assistance during an operation performed on an equipment is illustrated, in accordance with an embodiment of the present disclosure. FIG. 11 is explained in conjunction with FIG. 1-10. In an embodiment, the flow diagram 1100 may include a plurality of steps that may be performed by various modules of the authoring and rendering device 102 so as to author and render the XR experience to provide assistance during an operation performed on an equipment.

At step 1102, a training module may be received for an extended reality (XR) experience. It should be noted that the training module may be provided by a user via the I/O device 108. In an embodiment, the training module may include a set of views arranged in a predefined sequence for performing the operation. In an embodiment, each of the set of views may include one or more real-world objects and one or more training objects corresponding to the equipment. In an embodiment, the one or more real-world objects and the one or more training objects may also include the one or more Internet of Things (IoT) devices 112. The authoring and rendering device 102 may receive real-time IoT data from the one or more IoT devices 112.

The training module may further include an anchor specification corresponding to each of the set of views. In an embodiment, the anchor specification may include a spatial marker, an image marker or an object marker. The training module may further include a set of animation steps associated with the one or more real-world objects and the one or more training objects. In an embodiment, the set of animation steps may correspond to one or more steps to be performed for performing the operation. The training module may further include metadata corresponding to each of the set of animation steps. Further at step 1104, a video of a real-world scenario of the equipment corresponding to the XR experience may be received. Further at step 1106, a set of image frames may be detected in the video corresponding to a portion of the set of views based on the detection of the one or more real-world objects and the one or more training objects in the video.

Further at step 1108, a first set of three-dimensional (3D) views for each of the set of views and a second set of 3D views for each of the set of image frames may be created using a 3D-modelling tool. Further at step 1110, a unified XR content package may be generated for the XR experience based on the first set of 3D views, the second set of 3D views and the anchor specification.

To generate the unified XR content package, at step 1112, a set of augmented views may be determined by augmenting the second set of 3D views with respect to a portion of the first set of 3D views corresponding to the portion of the set of views based on the anchor specification. Further, to generate the unified XR content package, at step 1114, the set of augmented views, the first set of 3D views and the second set of 3D views, the set of animation steps associated with the one or more real-world objects and the one or more training objects and the metadata corresponding to each of the set of animation steps may be compiled in the predefined sequence, as will be described in greater detail in FIG. 11A below. In an embodiment, the unified XR content package may include a plurality of file formats that may be compatible with the plurality of viewing devices 114. The plurality of file formats may include, but is not limited to, a GL Transmission Format Binary (GLB) file format.

Further at step 1116, the XR experience may be rendered on one or more of the plurality of viewing devices 114 to provide assistance during the operation. In an embodiment, the real-time IoT data may also be rendered along with the XR experience indicating a real-time condition of the one or more IoT devices 112. To render the XR experience, at step 1118, a compatible format from the plurality of file formats with a corresponding client application of each of the one or more of the plurality of viewing devices 114 may be determined. In an embodiment, the XR experience may be rendered based on execution of a corresponding file formats compatible with each of the one or more of the plurality of viewing devices 114.

Referring now to FIG. 11A, a flow diagram 1100A of a method of compiling the set of augmented views of FIG. 11, in accordance with an embodiment of the present disclosure. FIG. 11A is explained in conjunction with FIG. 1-11. FIG. 11A corresponds to the step 1114 of FIG. 11. In an embodiment, the flow diagram 1100A may include a plurality of steps that may be performed by various modules of the authoring and rendering device 102 so as to compile the set of augmented views.

At step 1120, an animation corresponding to each of the set of animation steps may be selected from a predefined library of animations. Further at step 1122, the metadata may be associated for each of the set of animation steps. In an embodiment, the metadata may describe the one or more steps to be performed by the user. Further at step 1124, the unified XR content package may be stored on the server 118.

Referring now to FIG. 11B, a flow diagram of a method 1100B of processing a user query in conjunction with FIG. 11, in accordance with an embodiment of the present disclosure. In an embodiment, the flow diagram 1100B may include a plurality of steps that may be performed by various modules of the authoring and rendering device 102 so as to process the user query.

At step 1126, a user query may be received as an input by the user via the I/O device 108, requesting information corresponding to the one or more real-world objects and the one or more training objects being rendered while rendering the XR experience.

Further at step 1128, a response may be received to the user query from a generative AI model. In an embodiment, examples of the generative AI model may include, but are not limited to, a Generative Pre-trained Transformer (GPT), Bidirectional Encoder Representations from Transformer (BERT), CodeGen, etc. In an embodiment, the generative AI model may be trained based on a predefined specification data corresponding to the equipment, the one or more real-world objects and the one or more training objects. Further at step 1130, the response to the user query may be output along with the XR experience via the I/O device 108.

Referring now to FIG. 11C, a flowchart of a method 1100C of modulating the rendering of the XR experience in conjunction with FIG. 11, in accordance with an embodiment of the present disclosure. In an embodiment, the flow diagram 1100C may include a plurality of steps that may be performed by various modules of the authoring and rendering device 102 so as to modulate the rendering of the XR experience.

At step 1132, a user input may be received via the I/O device 108 for modulating the rendering of the XR experience based on a selection of the one or more steps via an interactive interface of the I/O device 108. Thereafter, at step 1134, the rendering of the XR experience may be modulated based on the user input.

Thus, the disclosed method 1100 and system 100 try to overcome the technical problem of providing effective, adaptable experiences related to operations and guidance for complex equipment using extended reality (XR) technologies. Operating complex machinery, such as industrial machines, often involves complex procedures that are challenging to convey through traditional methods. These procedures require clear, step-by-step instructions and visual aids to ensure that trainees can perform tasks accurately and safely. Conventional systems typically offer static instructions and lack the flexibility to adapt to the trainee's specific needs or preferences. For instance, they may not provide real-time adjustments based on the trainee's progress or questions.

Conventional systems typically offer static instructions and lack the flexibility to adapt to the trainee's specific needs or preferences. For instance, they may not provide real-time adjustments based on the trainee's progress or questions. Traditional systems may struggle to render dynamic and interactive content effectively, especially when incorporating live data, animations, and interactive elements within an XR environment. Ensuring that such content is accurately displayed and interacts with the user in real-time presents significant technical challenges.

The disclosed method 1100 and system 100 address these technical problems. The method 1100 and the system 100 dynamically generate and modulate XR experiences based on user inputs and real-time data, providing a highly adaptable and interactive XR environment. By incorporating real-time data from IoT devices, the method 1100 and the system 100 enhance the XR experience with live operational information, making the XR experience more realistic and contextually relevant. The system 100 includes interactive interfaces that allow users to select specific steps or details, which are then reflected in the XR rendering. This adaptability ensures that users receive tailored guidance and can focus on areas of particular interest or difficulty. The use of advanced rendering techniques and modulation modules enables the system 100 to effectively integrate and display complex 3D models, animations, and metadata. This approach ensures that the XR experience is both informative and visually engaging. The inclusion of a generative AI model for responding to user queries allows for the provision of contextual information and guidance.

As will be appreciated by those skilled in the art, the techniques described in the various embodiments discussed above are not routine, or conventional, or well-understood in the art. The techniques discussed above provide for authoring and rendering extended reality experiences.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described method 1100 and system 100 for authoring and rendering extended reality experiences. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for authoring and rendering extended reality (XR) experience to provide assistance during an operation performed on an equipment, the method comprising:
receiving, by an authoring and rendering device, a training module for the XR experience,
wherein the training module comprises:
a set of views arranged in a predefined sequence for performing the operation,
wherein each of the set of views comprises one or more real-world objects and one or more training objects corresponding to the equipment,
an anchor specification corresponding to each of the set of views;
a set of animation steps associated with the one or more real-world objects and the one or more training objects,
wherein the set of animation steps correspond to one or more steps to be performed for performing the operation;
metadata corresponding to each of the set of animation steps;
receiving, by the authoring and rendering device, a video of a real-world scenario of the equipment corresponding to the XR experience;
detecting, by the authoring and rendering device, a set of image frames in the video corresponding to a portion of the set of views based on the detection of the one or more real-world objects and the one or more training objects in the video;
creating, by the authoring and rendering device, a first set of three-dimensional (3D) views for each of the set of views and a second set of 3D views for each of the set of image frames using a 3D-modelling tool;
generating, by the authoring and rendering device, a unified XR content package for the XR experience based on the first set of 3D views, the second set of 3D views and the anchor specification by:
determining, by the authoring and rendering device, a set of augmented views by augmenting the second set of 3D views with respect to a portion of the first set of 3D views corresponding to the portion of the set of views based on the anchor specification; and
compiling, by the authoring and rendering device, the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package,
wherein the unified XR content package comprises a plurality of file formats that are compatible with a plurality of viewing devices; and
rendering, by the authoring and rendering device, the XR experience on one or more of the plurality of viewing devices to provide assistance during the operation,
wherein the XR experience is rendered based on execution of a corresponding file format from the plurality of file formats compatible with each of the one or more of the plurality of viewing devices.

2. The method of claim 1, wherein the compiling comprises:
selecting, by the authoring and rendering device, an animation corresponding to each of the set of animation steps from a predefined library of animations;
associating, by the authoring and rendering device, the metadata for each of the set of animation steps,
wherein the metadata describes the one or more steps to be performed by a user; and
storing, by the authoring and rendering device, the unified XR content package on a cloud-based server.

3. The method of claim 1, wherein the rendering of the XR experience comprises:
determining, by the authoring and rendering device, a compatible format from the plurality of file formats compatible with a corresponding client application of each of the one or more of the plurality of viewing devices.

4. The method of claim 3, wherein the one or more of the plurality of viewing devices comprises an augmented reality (AR) device, a virtual reality (VR) device and a smart device.

5. The method of claim 1, wherein the one or more real-world objects and the one or more training objects comprises one or more Internet of Things (IoT) devices,
wherein the one or more IoT devices are communicably coupled to the authoring and rendering device,
wherein the authoring and rendering device receives real-time IoT data from the one or more IoT devices, and
wherein the real-time IoT data is rendered along with the XR experience indicating a real-time condition of the one or more IoT devices.

6. The method of claim 1, further comprising:
receiving, by the authoring and rendering device, a user query via an input device, requesting information corresponding to the one or more real-world objects and the one or more training objects being rendered while rendering the XR experience;
receiving, by the authoring and rendering device, a response to the user query from a generative AI model, wherein the generative AI model is trained based on a predefined specification data corresponding to the equipment, the one or more real-world objects and the one or more training objects; and
outputting, by the authoring and rendering device, the response to the user query along with the XR experience.

7. The method of claim 1, comprising:
receiving, by the authoring and rendering device, a user input for modulating the rendering of the XR experience based on a selection of the one or more steps via an interactive interface; and
modulating, by the authoring and rendering device, the rendering of the XR experience based on the user input.

8. The method of claim 1, wherein the plurality of file formats comprises a GL Transmission Format Binary (GLB) file format.

9. The method of claim 1, wherein the anchor specification comprises a spatial marker, an image marker or an object marker.

10. A system for authoring and rendering extended reality (XR) experience to provide assistance during an operation performed on an equipment, comprising:
an authoring and rendering device comprising:
a processor; and
a memory communicably coupled to the processor, wherein the memory stores processor-executable instructions, which when executed by the processor, cause the processor to:
receive a training module for the XR experience,
wherein the training module comprises:
a set of views arranged in a predefined sequence for performing the operation,
wherein each of the set of views comprises one or more real-world objects and one or more training objects corresponding to the equipment,
an anchor specification corresponding to each of the set of views;
a set of animation steps associated with the one or more real-world objects and the one or more training objects,
wherein the set of animation steps correspond to one or more steps to be performed for performing the operation;
metadata corresponding to each of the set of animation steps;
receive a video of a real-world scenario of the equipment corresponding to the XR experience;
detect a set of image frames in the video corresponding to a portion of the set of views based on the detection of the one or more real-world objects and the one or more training objects in the video;
create a first set of three-dimensional (3D) views for each of the set of views and a second set of 3D views for each of the set of image frames using a 3D-modelling tool;
generate a unified XR content package for the XR experience based on the first set of 3D views, the second set of 3D views and the anchor specification, wherein to generate the unified XR content package, the processor-executable instructions cause the processor to:
determine a set of augmented views by augmenting the second set of 3D views with respect to a portion of the first set of 3D views corresponding to the portion of the set of views based on the anchor specification; and
compile the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package,
wherein the unified XR content package comprises a plurality of file formats that are compatible with a plurality of viewing devices; and
render the XR experience on one or more of the plurality of viewing devices to provide assistance during the operation,
wherein the XR experience is rendered based on execution of a corresponding file format from the plurality of file formats compatible with each of the one or more of the plurality of viewing devices.

11. The system of claim 10, wherein to compile, the process-executable instructions, cause the processor to:
select an animation corresponding to each of the set of animation steps from a predefined library of animations;
associate the metadata for each of the set of animation steps,
wherein the metadata describes the one or more steps to be performed by a user; and
store the unified XR content package on a cloud-based server.

12. The system of claim 10, wherein to render the XR experience, the processor-executable instructions, cause the processor to:
determine a compatible format from the plurality of file formats compatible with a corresponding client application of each of the one or more of the plurality of viewing devices.

13. The system of claim 12, wherein the one or more of the plurality of viewing devices comprises an augmented reality (AR) device, a virtual reality (VR) device and a smart device.

14. The system of claim 10, wherein the one or more real-world objects and the one or more training objects comprises one or more Internet of Things (IoT) devices,
wherein the one or more IoT devices are communicably coupled to the authoring and rendering device,
wherein the authoring and rendering device receives real-time IoT data from the one or more IoT devices, and
wherein the real-time IoT data is rendered along with the XR experience indicating a real-time condition of the one or more IoT devices.

15. The system of claim 10, wherein the processor-executable instructions, cause the processor to:
receive a user query via an input device, requesting information corresponding to the one or more real-world objects and the one or more training objects being rendered while rendering the XR experience;
receive a response to the user query from a generative AI model, wherein the generative AI model is trained based on a predefined specification data corresponding to the equipment, the one or more real-world objects and the one or more training objects; and
output the response to the user query along with the XR experience.

16. The system of claim 10, wherein the processor-executable instructions, cause the processor to:
receive a user input for modulating the rendering of the XR experience based on a selection of the one or more steps via an interactive interface; and
modulate the rendering of the XR experience based on the user input.

17. The system of claim 10, wherein the plurality of file formats comprises a GL Transmission Format Binary (GLB) file format.

18. The system of claim 10, wherein the anchor specification comprises a spatial marker, an image marker or an object marker.

19. A non-transitory computer-readable medium storing computer-executable instructions for authoring and rendering extended reality (XR) experience to provide assistance during an operation performed on an equipment, the computer-executable instructions configured for:
receiving a training module for the XR experience,
wherein the training module comprises:
a set of views arranged in a predefined sequence for performing the operation,
wherein each of the set of views comprises one or more real-world objects and one or more training objects corresponding to the equipment,
an anchor specification corresponding to each of the set of views;
a set of animation steps associated with the one or more real-world objects and the one or more training objects,
wherein the set of animation steps correspond to one or more steps to be performed for performing the operation;
metadata corresponding to each of the set of animation steps;
receiving a video of a real-world scenario of the equipment corresponding to the XR experience;
detecting a set of image frames in the video corresponding to a portion of the set of views based on the detection of the one or more real-world objects and the one or more training objects in the video;
creating a first set of three-dimensional (3D) views for each of the set of views and a second set of 3D views for each of the set of image frames using a 3D-modelling tool;
generating a unified XR content package for the XR experience based on the first set of 3D views, the second set of 3D views and the anchor specification by:
determining a set of augmented views by augmenting the second set of 3D views with respect to a portion of the first set of 3D views corresponding to the portion of the set of views based on the anchor specification; and
compiling the set of augmented views, the first set of 3D views and the second set of 3D views, the set of animation steps associated with the one or more real-world objects and the one or more training objects and the metadata corresponding to each of the set of animation steps in the predefined sequence to generate the unified XR content package,
wherein the unified XR content package comprises a plurality of file formats that are compatible with a plurality of viewing devices; and
rendering the XR experience on one or more of the plurality of viewing devices to provide assistance during the operation,
wherein the XR experience is rendered based on execution of a corresponding file format from the plurality of file formats compatible with each of the one or more of the plurality of viewing devices.

20. The non-transitory computer-readable medium of claim 19, wherein to compile, the computer-executable instructions are further configured for:
selecting an animation corresponding to each of the set of animation steps from a predefined library of animations;
associating the metadata for each of the set of animation steps,
wherein the metadata describes the one or more steps to be performed by a user; and
storing the unified XR content package on a cloud-based server.
